(19) United States
(12) Patent Application Publication
(10) Pub. No.: US 2021/0171734 A1
(43) Pub. Date: Jun. 10, 2021

(54) THERMALLY EXPANDABLE FIRE-RESISTANT RESIN COMPOSITION, THERMALLY EXPANDABLE FIRE-RESISTANT SHEET, AND METHOD FOR INSTALLING THERMALLY EXPANDABLE FIRE-RESISTANT SHEET

(71) Applicant: Panasonic Intellectual Property Management co., Ltd., Osaka (JP)

(72) Inventors: Kenji SAKAMOTO, Osaka (JP); Takaya NIU, Osaka (JP); Satoru MORIYA, Nara (JP)

(21) Appl. No.: 16/770,294

(22) PCT Filed: May 20, 2019
(86) PCT No.: PCT/JP2019/019876

§ 371 Date: Jun. 5, 2020

(30) Foreign Application Priority Data
Jul. 30, 2018 (JP) 2018-142955

(51) Int. Cl. C08K 5/521; C08K 5/053; C08K 3/22; C08K 3/32; B32B 27/12; C08K 5/16; E04B 1/94; B32B 17/02; B32B 27/24; B32B 5/06; C08L 101/12

(52) U.S. Cl. CPC C08K 5/521; C08L 2201/02; C08K 3/22; C08K 3/32; B32B 27/12; C08K 5/16; E04B 1/94; B32B 17/02; B32B 27/24; B32B 5/06; C08L 101/12; B32B 2307/7246; B32B 2250/02; B32B 2250/03; B32B 2607/00; B32B 2262/101; C08K 5/053

(57) ABSTRACT

A thermally expandable fire-resistant resin composition contains a metallocene plastomer; a nitrogen-containing foaming agent; a phosphorus flame retardant; a polyhydric alcohol; and a titanium dioxide.

### TECHNICAL FIELD

The present disclosure generally relates to thermally expandable fire-resistant resin compositions, thermally expandable fire-resistant sheets, and methods for installing the thermally expandable fire-resistant sheets. The present disclosure specifically relates to a thermally expandable fire-resistant resin composition suitable for wooden structural members, metal structural members, wooden underlying members, inorganic underlying members, and the like, a thermally expandable fire-resistant sheet including a resin layer formed from the thermally expandable fire-resistant resin composition, and a method for fixedly installing the thermally expandable fire-resistant sheet on an underlying member.

### BACKGROUND ART

Installation elements such as beams, columns, floors, walls, roofs, and staircases which require fire-resistant structures in buildings are formed mainly from concrete or metal such as H-beams and iron frames. In order to improve fire resistance, in particular, iron columns and beams are coated with a fire-resistant covering material. Coating with the fire-resistant covering material is mainly performed by wet rock wool spraying at a construction site. However, this method has a hygienic problem in that particulates are generated during the spraying. In terms of process, this method also has a problem that curing is required after spraying.

On the other hand, a plate-like member, for example, a calcium silicate board, a plasterboard, or the like may be used as a main material. However, these plate-like members are fragile and thus have a problem that they may be damaged, for example, broken or cracked, during transportation. Moreover, since the plate-like member is a heavy product and is bulky, a space for storing the plate-like member is required at an installation site.

To solve these problems, a thermally expandable fire-resistant sheet which is processable into a sheet shape and which is elastic has been proposed in recent years (for example, Patent Literatures 1 and 2).

### CITATION LIST

### Patent Literature

Patent Literature 1: JP 2003-64261 A

Patent Literature 2: WO 2012/132475 A1

### SUMMARY OF INVENTION

A thermally expandable fire-resistant resin composition according to one aspect of the present disclosure includes: a metallocene plastomer (A); a nitrogen-containing foaming agent (B); a phosphorus flame retardant (C); a polyhydric alcohol (D); and a titanium dioxide (E).

A thermally expandable fire-resistant sheet according to one aspect of the present disclosure includes: a resin layer formed from the thermally expandable fire-resistant resin composition.

A method for installing the thermally expandable fire-resistant sheet according to one aspect of the present disclosure includes: fixing the thermally expandable fire-resistant sheet to an architectural structure portion with a fixing tool.

### BRIEF DESCRIPTION OF DRAWINGS

FIG. 1 is a sectional view schematically illustrating a thermally expandable fire-resistant sheet according to one embodiment of the present disclosure; and

FIG. 2 is a sectional view schematically illustrating a state of use of the thermally expandable fire-resistant sheet.

### DESCRIPTION OF EMBODIMENTS

1. Schema

First, a background of accomplishment of the present invention will be described.

Installation elements such as beams, columns, floors, walls, roofs, and staircases which require fire-resistant structures in buildings are formed mainly from concrete or metal such as H-beams and iron frames. In order to improve fire resistance, in particular, iron columns and beams are coated with a fire-resistant covering material. Coating with the fire-resistant covering material is mainly performed by wet rock wool spraying at a construction site. However, this method has a hygienic problem in that particulates are generated during the spraying. In terms of process, this method also has a problem that curing is required after spraying.

To solve these problems, a thermally expandable fire-resistant sheet which is processable into a sheet shape and which is elastic has been proposed in recent years. It is proposed that such a thermally expandable fire-resistant sheet is combusted and expanded by heat to form a heat insulating layer of a combustion residue (e.g., JP 2003-64261 A and WO 2012/132475 A1).

The foamable fireproof sheet disclosed in JP 2003-64261 A, however, has a problem that securing, for a long period of time, a satisfactory foaming property against fire heat is difficult.

Moreover, the fire-resistant sheet made of a fire-resistant rubber composition disclosed in WO 2012/132475 is configured to retain the shape of the burned residue (foamed heat-insulating layer) formed by exposure to heat of fire flame and the like but has a problem that the fire-resistant sheet is difficultly maintained in a state where it is fit in an underlying member and the conformability of the fire-resistant sheet to the underlying member is low.

Thus, to provide a thermally expandable fire-resistant resin composition and a thermally expandable fire-resistant sheet which are made fire-resistant and durable for a long period of time and which are excellent in shape retainability and conformability, and a method for installing the thermally expandable fire-resistant sheet, the present inventors have completed the present disclosure.

The thermally expandable fire-resistant resin composition according to the present embodiment includes: a metallocene plastomer (A); a nitrogen-containing foaming agent (B); a phosphorus flame retardant (C); a polyhydric alcohol (D); and a titanium dioxide (E). Moreover, a thermally expandable fire-resistant sheet 1 can be produced from a resin layer 11 formed from the thermally expandable fire-resistant resin composition. That is, the thermally expandable fire-resistant sheet 1 includes the resin layer 11 formed from the thermally expandable fire-resistant resin composition. The thermally expandable fire-resistant sheet 1 is usable by being fixed to an architectural structure portion 20 as shown in, for example, FIG. 2. The architectural structure portion 20 is a member included in a building and is, for example, a wall, a floor, a roof, a column, a staircase, or a beam. Examples of the architectural structure portion 20 include an underlying member 21. The thermally expandable fire-resistant resin composition of the present embodiment and the thermally expandable fire-resistant sheet 1 including the resin layer 11 formed from the thermally expandable fire-resistant resin composition are fire-resistant and durable for a long period of time. Even when exposed to fire heat, the thermally expandable fire-resistant resin composition of the present embodiment and the thermally expandable fire-resistant sheet 1 including the resin layer 11 formed from the thermally expandable fire-resistant resin composition are excellent in shape retainability and conformability to the architectural structure portion 20.

Incidentally, a thermally expandable fire-resistant sheet used as an underlying member of walls of buildings and the like is used by being combined with a protective layer such as an exterior material provided on its outer side. Moreover, in an installation part of the architectural structure portion 20 serving as the underlying member 21 of a wall or the like, the thermally expandable fire-resistant sheet is fixable to a wooden structure portion, a metal structure portion, a wooden underlying member, an inorganic underlying member, or the like. Depending on an environment surrounding a place where the thermally expandable fire-resistant sheet is used, the thermally expandable fire-resistant sheet may be exposed to harsh conditions such as a hot and humid condition and a condition of repeating freezing and thawing although a protective layer such as the exterior material or the like is provided to the thermally expandable fire-resistant sheet. Moreover, a location where the thermally expandable fire-resistant sheet is installed as described above may be located in the underlying member or the like, or the thermally expandable fire-resistant sheet may be fixed with the fixing tool or the like, and therefore, replacing or repainting of the thermally expandable fire-resistant sheet is difficult. For this reason, the thermally expandable fire-resistant sheet desirably maintains its long-term durability.

As a result of intensive studies, the present inventors found that blending a plasticizer and process oil and the like having a relatively high molecular mobility with a material for forming the thermally expandable fire-resistant sheet reduces the gas barrier property of the thermally expandable fire-resistant sheet. In this case, it was found that when the thermally expandable fire-resistant sheet is exposed, for a long period of time, to a hot and humid condition and a condition of repeating freezing and thawing, it becomes difficult to maintain satisfactory foamability against fire heat, which influences the fire resistance of the thermally expandable fire-resistant sheet. Alternatively, in the case of a heat-resistant sheet containing a high fire-resistant rubber composition, it was found that the shape of a burned residue (foamed heat-insulating layer) was maintainable but the conformability to the underlying member is more likely to decrease. The fire-resistant sheet in this case has a problem that the return angle at the time of bending is large at an internal corner and an external corner of the underlying member of a wall, which makes it difficult for the fire-resistant sheet so conform to the internal corner and the external corner is difficult.

In view of the foregoing, the present inventors found the configuration of the present disclosure. That is, the thermally expandable fire-resistant resin composition according to the present embodiment includes: a metallocene plastomer (A); a nitrogen-containing foaming agent (B); a phosphorus flame retardant (C); a polyhydric alcohol (D); and a titanium dioxide (E). The reason why the thermally expandable fire-resistant sheet 1 including the resin layer 11 formed from the thermally expandable fire-resistant resin composition according to the present embodiment is made fire-resistant and durable for a long period of time and is excellent in shape retainability and sheet conformability is not clear but is probably explained as follows.

The thermally expandable fire-resistant resin composition is contained in the resin layer 11 included in the thermally expandable fire-resistant sheet 1. That is, the resin layer 11 can be formed from the thermally expandable fire-resistant resin composition. Thus, the resin layer 11 contains: the metallocene plastomer (A); the nitrogen-containing foaming agent (B); the phosphorus flame retardant (C); the polyhydric alcohol (D); and the titanium dioxide (E) of the thermally expandable fire-resistant resin composition. When the resin layer 11 is exposed to, for example, fire heat, the resin layer 11 expands and foams by the action of the nitrogen-containing foaming agent (B) to form a foamed heat-insulating layer. In this manner, the resin layer 11 forms the foamed heat-insulating layer, thereby blocking thermal input and output on both sides of the foamed heat-insulating layer. The temperature of fire heat is, for example, higher than or equal to 600° C.

In particular, the thermally expandable fire-resistant resin composition contains the metallocene plastomer (A), and therefore, the thermally expandable fire-resistant resin composition can impart fire resistance to the thermally expandable fire-resistant sheet. Moreover, even when the metallocene plastomer (A) is exposed to the harsh conditions, such as a hot and humid condition and a condition of repeating freezing and thawing, the metallocene plastomer (A) can impart a gas barrier property to the thermally expandable fire-resistant resin composition, and therefore, the thermally expandable fire-resistant sheet 1 can secure its long-term durability. Moreover, even when the thermally expandable fire-resistant sheet 1 is exposed to fire heat, the metallocene plastomer (A) can impart conformability suitable for the architectural structure portion 20.

Thus, the thermally expandable fire-resistant resin composition according to the present embodiment and the thermally expandable fire-resistant sheet 1 including the resin layer 11 formed from the thermally expandable fire-resistant resin composition are made fire-resistant and durable for a long period of time and is excellent in shape retainability and conformability.

2. Details

The respective components included as components of the thermally expandable fire-resistant resin composition and the thermally expandable fire-resistant sheet 1 according to the present embodiment will be described specifically below. Note that in the following description, for convenience of explanation, a “resin layer formed from the thermally expandable fire-resistant resin composition” may simply be referred to as a “resin layer” unless otherwise specified. Moreover, a “condition of repeating freezing and thawing” may simply be referred to as a “freezing and thawing condition”. Furthermore, a “solid content of the resin composition” refers to the total content of solid components of components contained in the resin composition and does not include liquid components such as a solvent.

(1.1) Metallocene Plastomer (A)

When the resin layer 11 formed from thermally expandable fire-resistant resin composition is heated, the metallocene plastomer (A) can make the resin layer 11 be an excellent foamed heat-insulating layer. Moreover, the metallocene plastomer (A) can impart the gas barrier property to the thermally expandable fire-resistant sheet 1. Furthermore, when the thermally expandable fire-resistant sheet 1 is fixed to the architectural structure portion 20 such as the underlying member 21, the metallocene plastomer (A) can impart the conformability to the thermally expandable fire-resistant sheet 1. Note that “plastomer” means a polymer having the property of easily flowable and deformable into a shape by heat and solidifiable in the shape. The plastomer is a term opposite in meaning to an elastomer (which has such a property that when external force is applied to the elastomer, the elastomer deforms according to the external force, and when the external force is removed, the elastomer returns to its original shape in a short time), and the plastomer does not exhibit elastic deformation unlike the elastomer but easily deforms plastically. In the present embodiment, the metallocene plastomer (A) is a polymer obtained through polymerization of ethylene and olefin, such as α-olefin, in the presence of a catalyst, namely, metallocene as the catalyst.

The metallocene plastomer (A) has high transparency, high flexibility and high heat resistance, as well as excellent impact resistance. Therefore, the metallocene plastomer (A) can impart impact resistance and flexibility to the resin layer 11 obtained by molding the thermally expandable fire-resistant resin composition.

A method of producing the metallocene plastomer (A) is not particularly limited, but as described above, the metallocene plastomer (A) is obtained by accordingly polymerizing ethylene and olefin such as α-olefin in the presence of a metallocene catalyst. Examples of specific products of the metallocene plastomer (A) include C6 EXCELLEN FX (FX201, FX301, FX307, and FX402) and C4 EXCELLEN FX (FX352, FX555, FX551, and FX558) of EXCELLEN (registered trademark) FX series manufactured by Sumitomo Chemical Company, Limited, and Kernel (KF260T) manufactured by Japan polyethylene Corporation. Of course, the metallocene plastomer (A) is not limited to the specific examples mentioned above but is at least a copolymer obtained by polymerizing olefin in the presence of the metallocene catalyst as described above.

Note that the metallocene plastomer (A) is distinguished from a polymer (F) which will be described later. Therefore, components included in the metallocene plastomer (A) are not included in the polymer (F), and components included in the polymer (F) are not included in the metallocene plastomer (A).

The melt mass-flow rate (MFR) of the metallocene plastomer (A) is preferably within a range of greater than or equal to 2 g/10 min and less than or equal to 40 g/10 min. When the melt mass-flow rate is greater than or equal to 2 g/10 min, it is possible to satisfactorily maintain the conformability when the thermally expandable fire-resistant sheet 1 is disposed in the architectural structure portion 20 such as the underlying member 21. Moreover, at the time of freezing and thawing, the resin layer 11 of the thermally expandable fire-resistant sheet 1 does not easily become brittle, and thus it is possible to satisfactorily secure long-term durability against the freezing and thawing. When the melt mass-flow rate is less than or equal to 40 g/10 min, it is possible to satisfactorily maintain the shape retainability of the foamed heat-insulating layer formed by exposure to fire flame. Moreover, in this case, it is possible to make the gas barrier property of the thermally expandable fire-resistant sheet 1 less likely to decrease, and to satisfactorily secure the long-term durability under a high-temperature and humidity atmosphere. The melt mass-flow rate is more preferably within a range of greater than or equal to 4 g/10 min and less than or equal to 30 g/10 min. Note that the melt mass-flow rate is measurable by a method compliant with JIS K6924-1.

The content of the metallocene plastomer (A) based on 100 parts by mass of a solid content of the thermally expandable fire-resistant resin composition is preferably within a range of greater than or equal to 15 parts by mass and less than or equal to 40 parts by mass. When the content of the metallocene plastomer (A) is greater than or equal to 15 parts by mass, it is possible to improve the toughness of the thermally expandable fire-resistant sheet 1 when the resin layer 11 is formed from the thermally expandable fire-resistant resin composition. Moreover, in this case, it is possible to secure a satisfactory gas-barrier property of the thermally expandable fire-resistant sheet 1 and satisfactorily maintain the long-term durability under the hot and humid condition. When the content of the metallocene plastomer (A) is less than or equal to 40 parts by mass, it is possible to maintain the shape of the foamed heat-insulating layer when the thermally expandable fire-resistant sheet 1 is exposed to fire heat. The content of the metallocene plastomer (A) based on 100 parts by mass of the solid content of the thermally expandable fire-resistant resin composition is more preferably within a range of greater than 18 parts by mass and less than 35 parts by mass, much more preferably within a range of greater than 18 parts by mass and less than 28 parts by mass.

(1.2) Nitrogen-Containing Foaming Agent (B)

The nitrogen-containing foaming agent (B) is a foaming agent containing nitrogen atoms. The nitrogen-containing foaming agent (B) decomposes when exposed to fire heat and generates a non-combustible gas such as nitrogen and/or ammonia. The nitrogen-containing foaming agent (B) further has a role of expanding and foaming the metallocene plastomer (A) carbonizing due to fire heat and the polyhydric alcohol (D) to form the foamed heat-insulating layer. Note that also when the thermally expandable fire-resistant resin composition contains the polymer (F) described later, the nitrogen-containing foaming agent (B) can act in the same manner. Moreover, the nitrogen-containing foaming agent (B) can impart toughness to the thermally expandable fire-resistant sheet 1. This enables the thermally expandable fire-resistant sheet 1 to exhibit satisfactory conformability to the architectural structure portion 20.

The nitrogen-containing foaming agent (B) is not particularly limited, but examples of the nitrogen-containing foaming agent (B) include melamine, a melamine derivative, dicyandiamide, azodicarbonamide, urea, and guanidine. That is, the nitrogen-containing foaming agent (B) contains at least one selected from the group consisting of the above-mentioned examples. In light of the generation efficiency of the noncombustible gas, the conformability to the architectural structure portion 20, and the fire resistance, the nitrogen-containing foaming agent (B) preferably contains at least one of melamine or dicyandiamide and more preferably contains at least melamine.

The content of the nitrogen-containing foaming agent (B) based on 100 parts by mass of the solid content of the thermally expandable fire-resistant resin composition is preferably within a range of greater than or equal to 5 parts by mass and less than or equal to 25 parts by mass. When the content (B) of the nitrogen-containing foaming agent (B) is greater than or equal to 5 parts by mass, it is possible to form a satisfactory foamed heat-insulating layer at the time of exposure to fire heat. In addition, it is possible to secure the toughness of the thermally expandable fire-resistant sheet 1. When the content of the nitrogen-containing foaming agent (B) is less than or equal to 25 parts by mass, it is possible to secure the shape retainability of the foamed heat-insulating layer formed by fire heat. In addition, even if freezing and thawing are repeated, the thermally expandable fire-resistant sheet 1 is less likely to harden, and it is possible to suppress degradation of the fire resistance. The content of the nitrogen-containing foaming agent (B) based on 100 parts by mass of the solid content of the thermally expandable fire-resistant resin composition is more preferably greater than or equal to 8 parts by mass and less than or equal to 23 parts by mass.

(1.3) Phosphorus Flame Retardant (C)

The phosphorus flame retardant (C) is a flame retardant containing at least one of phosphorus alone or a phosphorus compound. The phosphorus flame retardant (C) has the effect of dehydrating the polyhydric alcohol (D) when exposed to fire heat to form a thin film called “char” on a surface of a foamed cross section layer. Moreover, the phosphorus flame retardant (C) reacts with the titanium dioxide (E) to produce a titanium pyrophosphate when heated at a high temperature higher than or equal to 600° C. The titanium pyrophosphate remains as an ashed component in the foamed heat-insulating layer, thereby improving the shape retainability of the foamed heat-insulating layer.

The phosphorus flame retardant (C) is not particularly limited, and examples thereof includes red phosphorus, a phosphate ester, a phosphate metal salt, a phosphate ammonium, phosphate melamine, a phosphate amide, and ammonium polyphosphates. Examples of the phosphate ester include triphenylphosphate and tricresyl phosphate. Examples of the metal phosphate salt include sodium phosphate and magnesium phosphate. Examples of the ammonium polyphosphates include a polyphosphate ammonium and a melamine modified ammonium polyphosphate. Of these substances, the ammonium polyphosphates are preferably contained in the phosphorus flame retardant (C), in particular, in view of the satisfactory formation of the foamed heat-insulating layer, the shape retainability and long-term durability of the foamed heat-insulating layer. The phosphorus flame retardant (C) may be only one kind or two or more kinds of the group consisting of the above-mentioned examples. When the ammonium polyphosphates are exposed to fire heat, and the temperature of the ammonium polyphosphates reaches a decomposition temperature, the ammonium polyphosphates desorb ammonia to produce a phosphoric acid and a condensed phosphoric acid. The phosphoric acid and the condensed phosphoric acid dehydrate and carbonize the polyhydric alcohol (D), thereby forming char. Moreover, an ammonia gas generated by decomposition of the ammonium polyphosphates, an ammonia gas and a nitrogen gas generated by decomposition of the nitrogen-containing foaming agent (B), and the like cause the entirety of the thermally expandable fire-resistant resin composition to expand and foam. The generation of non-combustible gases such as the ammonia gas and the nitrogen gas reduces the concentration of oxygen, and thus, burning is further suppressible. Moreover, the ammonium polyphosphates also decompose when heated at a high temperatures higher than or equal to 600° C., and the ammonium polyphosphates react with the titanium dioxide (E), thereby producing the titanium pyrophosphate. The titanium pyrophosphate remains as an ashed component in the foamed heat-insulating layer, thereby improving the shape retainability of the foamed heat-insulating layer.

The content of the phosphorus flame retardant (C) based on 100 parts by mass of the solid content of the thermally expandable fire-resistant resin composition is preferably within a range of greater than or equal to 20 parts by mass and less than or equal to 50 parts by mass. When the content of the phosphorus flame retardant (C) is greater than or equal to 20 parts by mass, it is possible to effectively carbonize and foam the thermally expandable fire-resistant sheet 1 including the resin layer 11. Further, it is possible to secure the shape retainability of the foamed heat-insulating layer. When the content of the phosphorus flame retardant (C) is less than or equal to 50 parts by mass, it is possible to secure fire resistance in the case of an environment being hot and humid. The content of the phosphorus flame retardant (C) based on 100 parts by mass of the solid content of the thermally expandable fire-resistant resin composition is more preferably greater than or equal to 30 parts by mass and less than or equal to 50 parts by mass.

(1.4) Polyhydric Alcohol (D)

The polyhydric alcohol (D) is dehydrated and carbonized by the phosphorus flame retardant (C) when exposed to fire heat and contributes to the formation of the foamed heat-insulating layer from the resin layer 11. The decomposition temperature of the polyhydric alcohol (D) is preferably higher than or equal to 180° C., more preferably higher than or equal to 220° C. Examples of the polyhydric alcohol (D) include monopentaerythritol, dipentaerythritol and tripentaerythritol, poly saccharide such as starch and cellulose, and an oligosaccharide such as glucose and fructose. The polyhydric alcohol (D) may be one of, or a combination of two or more of, the above-mentioned components. In particular, the polyhydric alcohol (D) preferably contains at least one selected from the group consisting of monopentaerythritol, dipentaerythritol, and tripentaerythritol. In this case, the foamability of the thermally expandable fire-resistant sheet 1 can be particularly improved.

The content of the polyhydric alcohol (D) is preferably within a range of greater than or equal to 5 parts by mass and less than or equal to 25 parts by mass based on 100 parts by mass of the thermally expandable fire-resistant resin composition. When the content of the polyhydric alcohol (D) is greater than or equal to 5 parts by mass, it is possible to satisfactorily form the foamed heat-insulating layer from the resin layer 11 containing the thermally expandable fire-resistant resin composition. It is also possible to secure the shape retainability of the foamed heat-insulating layer. When the content of the polyhydric alcohol (D) is less than or equal to 25 parts by mass, it is possible to maintain the gas barrier property of the thermally expandable fire-resistant sheet 1 including the resin layer 11 even under the hot and humid condition, and to maintain satisfactory fire resistance. It is also possible to secure the conformability of the thermally expandable fire-resistant sheet 1 to the architectural structure portion 20.

Here, the weight ratio [(B)/(D)] of the nitrogen-containing foaming agent (B) to the polyhydric alcohol (D) is preferably within a range of greater than or equal to 0.2 and less than 4.0. When the weight ratio [(B)/(D)] is within this range, it is possible to secure the gas barrier property under the hot and humid condition and under a freezing and thawing condition, and in case of fire, it is possible to secure the fire resistance and the conformability to the architectural structure portion 20. That is, in this case, the thermally expandable fire-resistant sheet 1 can form a foamed heat-insulating layer excellent in shape retainability while securing the fire resistance and the conformability. Therefore, the foamed heat-insulating layer formed from the resin layer 11 by fire flame is hardly detached from the architectural structure portion 20 and thus, it is possible to suppress fire from spreading to a building and collapsing of the building due to the flame.

(1.5) Titanium Dioxide (E)

When the titanium dioxide (E) is heated to a high temperature higher than or equal to 600° C., the titanium dioxide (E) reacts with the phosphorus flame retardant (C), thereby producing titanium pyrophosphate. The titanium pyrophosphate remains as an ashed component in the foamed heat-insulating layer, thereby improving the shape retainability of the foamed heat-insulating layer.

The crystalline structure of the titanium dioxide (E) may be anatase-type or rutile-type but is not limited these examples. An average particle diameter of the titanium dioxide (E) is preferably within a range of greater than or equal to 0.01 μm and less than or equal to 200 μm, more preferably within a range of greater than or equal to 0.1 μm and less than or equal to 100 μm. Note that the average particle diameter refers to a particle diameter at a point corresponding to 50% in a cumulative volume distribution curve of a particle size distribution obtained on a volumetric basis, where a total volume is 100%, that is, refers to a diameter (D50) corresponding to 50% in the volume-based cumulative. The average particle diameter is obtained by measuring with, for example, a laser diffraction particle size distribution measurement device.

The content of the titanium dioxide (E) based on 100 parts by mass of the solid content of the thermally expandable fire-resistant resin composition is preferably within a range of greater than or equal to 5 parts by mass and less than or equal to 30 parts by mass. When the content of the titanium dioxide (E) is greater than or equal to 5 parts by mass, it is possible to produce sufficient titanium pyrophosphates by heat at a high temperature higher than or equal to 600° C. Thus, the titanium pyrophosphates as ashed components sufficiently remain in the foamed heat-insulating layer, thereby further improving the shape retainability of the foamed heat-insulating layer. When the content of the titanium dioxide (E) is less than or equal to 30 parts by mass, it is possible to suppress a decrease in the foaming ratio and further improve the fire resistance and the conformability to the architectural structure portion 20 at the time of freezing and thawing.

(1.6) Polymer (F)

The thermally expandable fire-resistant resin composition preferably further contains the polymer (F) other than the metallocene plastomer (A) described above. The polymer (F) is preferably a polymer component other than the metallocene plastomer (A) and has a water vapor transmission rate higher than or equal to 100 g/m²·24 h. When the water vapor transmission rate of the polymer (F) is higher than or equal to 100 g/m²·24 h, it is possible to satisfactorily secure the gas barrier property of the thermally expandable fire-resistant sheet 1. When the thermally expandable fire-resistant resin composition contains the polymer (F), it is possible to further improve the conformability and fire resistance suitable for the architectural structure portion 20 while maintaining the shape retainability of the foamed heat-insulating layer formed by expanding and foaming the resin layer 11 formed from the thermally expandable fire-resistant resin composition by flame. Note that the water vapor transmission rate is measurable by a method specified in Japanese Industrial Standards (JIS) K 7129.

The polymer (F) is not particularly limited as long as it satisfies the above-specified conditions. Examples of the polymer (F) include butyl rubber (IIR), polysulfide rubber (T), epichlorohydride rubber (CO, ECO), nitrile rubber (NBR), natural rubber (NR), styrene butadiene rubber (SBR), butadiene rubber (BR), ethylene propylene rubber (EPM, EPDM), polyolefin, an ethylene-vinyl acetate copolymer, and a thermoplastic elastomer. Of these examples, the ethylene-vinyl acetate copolymer is preferably contained, because in this case, it is possible to further improve the conformability and fire resistance suitable for the architectural structure portion 20 while the shape retainability of the foamed heat-insulating layer is maintained. Note that the thermoplastic elastomer is a component that softens to show fluidity when heated and returns to a rubber-like state when cooled.

When the thermally expandable fire-resistant resin composition contains the polymer (F), the weight ratio [(A)/(F)] of the metallocene plastomer (A) to the polymer (F) is preferably greater than or equal to 1.0. In this case, it is possible to impart further improved fire resistance and gas barrier property to the resin layer 11, and to more easily secure the conformability, suitable for the architectural structure portion 20, of the thermally expandable fire-resistant sheet 1. Note that the weight ratio [(A)/(F)] may be less than 1.0. Moreover, an upper limit of the weight ratio [(A)/(F)] is not particularly limited but is, for example, 100.

The content of the polymer (F) is preferably within a range of greater than or equal to 3 parts by mass and less than or equal to 40 parts by mass based on 100 parts by mass of the thermally expandable fire-resistant resin composition. The total content of the polymer (F) and the metallocene plastomer (A) is preferably within a range of greater than or equal to 15 parts by mass and less than or equal to 45 parts by mass based on 100 parts by mass of the thermally expandable fire-resistant resin composition.

(1.7) Others

The thermally expandable fire-resistant resin composition may contain any additive such as a plasticizer, a tackifier, an inorganic filler, an antioxidant, a lubricant, and a processing aid if needed within a range that does not impair the effectiveness of the present embodiment.

Examples of the plasticizer include, but are not limited to, hydrocarbons, phthalic acids, phosphate esters, adipate esters, sebacic acid esters, ricinoleic acid esters, polyesters, epoxies, and chlorinated paraffins. In the present embodiment, the thermally expandable fire-resistant resin composition preferably contains no plasticizer. When the thermally expandable fire-resistant resin composition contains no plasticizer, it is possible to further improve the gas barrier property of the thermally expandable fire-resistant sheet 1 formed from the thermally expandable fire-resistant resin composition.

Examples of the adhesives include, but are not limited to, a rosin resin, a rosin derivative, damul, a polyterpene resin, modified terpene, an aliphatic hydrocarbon resin, a cyclopentadiene resin, an aromatic petroleum resin, a phenol resin, an alkylphenol-acetylene resin, a styrene resin, a xylene resin, a coumarone-indene resin, and a vinyl toluene-α methylstyrene copolymer.

Examples of the inorganic filler include, but are not particularly limited to, an inorganic salt, an inorganic oxide, an inorganic fiber, and inorganic fine particles. Examples of the inorganic salt include calcium carbonate, aluminum hydroxide, magnesium hydroxide, kaolin, clay, bentonite, and talc. Examples of the inorganic oxide include glass flakes and wollastonite. Examples of the inorganic fiber include rock wool, glass fiber, carbon fiber, ceramic fiber, alumina fiber, and silica fiber. Examples of the inorganic fine particles include carbon particles and fumed silica particles.

Examples of the antioxidant include, but are not limited to, an antioxidant containing a phenol compound, an antioxidant containing sulfur atoms, and an antioxidant containing a phosphite compound.

Examples of the lubricant include, but are not limited to, mineral or petroleum-based waxes, vegetable or animal waxes, ester waxes, organic acids, organic alcohols, and an amide-based compound. Examples of the mineral or petroleum-based waxes include polyethylene, paraffins and montanoic acids. Examples of the vegetable or animal waxes include tall oil, factice oil, beeswax, carnauba wax, and lanolin. Examples of the organic acids include a stearic acid, a palmitic acid, and ricinoleic acid. Examples of the organic alcohols include a stearyl alcohol. Examples of the amide-based compound includes dimethylbisamide.

Examples of the processing aid include, but are not limited to, chlorinated polyethylene, a methyl methacrylate-ethyl acrylate copolymer, and a high-molecular-weight polymethyl methacrylate.

Note that the other components such as the additives described above are examples and are not limited to these examples. Any component may be accordingly blended depending on properties required for the thermally expandable fire-resistant resin composition and the thermally expandable fire-resistant sheet described later and on the method for installing the thermally expandable fire-resistant sheet.

(1.8) Method of Producing Resin Layer

The resin layer 11 formed from the thermally expandable fire-resistant resin composition may be produced, for example, as described below.

The resin layer 11 is produced by preparing a mixture by mixing the components (A) to (E) described above and optionally the component (F) and other components, and by accordingly shaping the mixture. Examples of a method for preparing the mixture include a kneading method, a suspension method, a warming and melting method. Examples of the kneading device include, but are not particularly limited to, a pressurizing kneader, an extruder, a Banbury mixer, a kneader mixer, and a two-piece roll. A kneading temperature is a temperature at which a resin composition is appropriately melted, is at least a temperature at which the polyhydric alcohol (D) is not decomposed, and is, for example, within a range of higher than or equal to 80° C. and lower than or equal to 200° C. The mixture prepared by, for example, the kneading is formed into a sheet by a molding method such as hot press molding, extrusion molding, or calendering, thereby producing the resin layer 11.

The resin layer 11 thus produced to have a sheet shape is usable as the thermally expandable fire-resistant sheet 1 described later.

(2) Thermally Expandable Fire-Resistant Sheet

Next, the thermally expandable fire-resistant sheet 1 will be described.

The thermally expandable fire-resistant sheet 1 includes the resin layer 11 formed from the thermally expandable fire-resistant resin composition. That is, the thermally expandable fire-resistant sheet 1 contains the components described above included in the thermally expandable fire-resistant resin composition. Thus, the thermally expandable fire-resistant sheet 1 is made fire-resistant and durable for a long period of time and is excellent in shape retainability and sheet conformability.

The thickness of the resin layer 11 of the thermally expandable fire-resistant sheet 1 is not particularly limited but is preferably within a range of greater than or equal to 0.1 mm and less than or equal to 5 mm in terms of the conformability to the architectural structure portion 20 when the thermally expandable fire-resistant sheet 1 is installed in the architectural structure portion 20 such as, for example, an underlying member. The thickness of the resin layer 11 of the thermally expandable fire-resistant sheet 1 is more preferably within a range of greater than or equal to 0.3 mm and less than or equal to 3 mm.

The thermally expandable fire-resistant sheet 1 may consist of the resin layer 11 formed in a sheet shape or may include the resin layer 11 and layers such as an inorganic layer, an organic layer, and a metal layer stacked on one surface of the resin layer 11. The thickness of each of the inorganic layer, the organic layer, and the metal layer, and the number, type, order, and the like of these layers stacked are not particularly limited and is selected in accordance with place, object, and the like of use. The thickness (total thickness when two or more layers are stacked) of the layers such as the inorganic layer, the organic layer, and the metal layer is, for example, within a range of greater than or equal to 0.2 mm and less than or equal to 1 mm.

The thermally expandable fire-resistant sheet 1 of the present embodiment includes the resin layer 11 described above and an inorganic layer 12 on the resin layer 11. Examples of the inorganic layer 12 include inorganic fiber such as rock wool, glass wool, glass cloth, and ceramic wool. Among them, glass fiber is preferably contained in the inorganic layer 12. When the inorganic layer 12 contains glass fiber, the foamed heat-insulating layer formed by expansion and foaming of the resin layer 11 by fire can be made less likely to fall off even if an thermally expandable fire-resistant sheet 1 having a relatively large area is fixed to the architectural structure portion 20 such as the underlying member 21 by a tool such as a tucker. The glass fiber is preferably glass paper, and preferably has basis weight (weight per unit area) greater than or equal to 10 g/m² and less than or equal to 100 g/m² and more preferably greater than or equal to 30 g/m² and less than or equal to 60 g/m².

Examples of the organic layer include: ether-based resins such as polyolefin resins (e.g., a polyethylene resin and a polypropylene resin), a polystyrene resin, polyester resins, a polyurethane resin, and polyamide resins; unsaturated ester resins; and copolymer resins such as an ethylene vinyl acetate copolymer, an ethylene vinyl alcohol copolymer, and a styrene butadiene copolymer. Examples of the form of the organic layer include a film and nonwoven fabric.

Examples of materials for the metal layer include iron, steel, stainless steel, galvanized steel, aluminum zinc alloy plated steel, and aluminum. In particular, an aluminum foil or the like is preferable in terms of handling property.

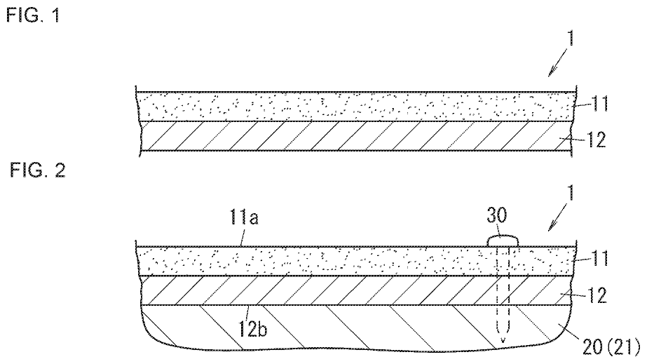

The thermally expandable fire-resistant sheet 1 which is shown in FIG. 1 and which includes the resin layer 11 and at least one of the layers described above (the inorganic layer 12 in FIG. 1) may be produced, for example, as described below.

The resin layer 11 formed into a film shape and described in (1.8) and the inorganic layer 12 are stacked in this order and are integrated with each other in an appropriate method, thereby producing the thermally expandable fire-resistant sheet 1. In this case, the thermally expandable fire-resistant sheet 1 has a 2-layer structure constituted by the resin layer 11 of the thermally expandable fire-resistant resin composition and the inorganic layer 12. Note that the thermally expandable fire-resistant sheet 1 may include three or more layers stacked by further stacking an inorganic layer and the like on an opposite surface of the inorganic layer 12 from the resin layer 11. Moreover, the molding method and temperature and pressure during the molding may be similar to those in (1.8).

(3) Method for Installing Thermally Expandable Fire-Resistant Sheet

The thermally expandable fire-resistant sheet 1 described in (2) is installed by being fixed to the architectural structure portion 20 such as the underlying member 21 with a fixing tool 30 as shown in FIG. 2. Specifically, as illustrated in, for example, FIG. 2, a surface 12b of the inorganic layer 12 of the thermally expandable fire-resistant sheet 1 opposite from the resin layer 11 is stacked on the architectural structure portion 20. Subsequently, the inorganic layer 12 of the resin layer 11 can be installed by being fixed with a fixing tool 30 from a surface 11a opposite from the inorganic layer 12. Examples of the architectural structure portion 20 (underlying member 21) include, but is not limited to, a wall, a floor, a roof, a column, and a beam. Examples of a material for the underlying member 21 includes, but is not limited to a slate board, a ceramic board, autoclaved lightweight aerated concrete (ALC), a concrete plate, various types of cement boards, a silicic acid calcium boards, a hydrous inorganic substance containing board, a plasterboard, a wood pieces cement board, and a wood board. Examples of the wood board includes: a composite board, an oriented strand board (OSB), a particleboard, cross laminated timber (CLT), and laminated wood. As an underlying member itself, a material having strength as a face material is preferably used. Examples of the method of fixing the thermally expandable sheet to the underlying member include a method using a fixing tool 30 such as a tapping screw, and a method using a tool such as a tucker to drive fixing tools 30 such as staples. Examples of the fixing tool 30 for fixing the thermally expandable fire-resistant sheet 1 include a sticking agent and an adhesive agent. To fix the thermally expandable fire-resistant sheet 1, two or more fixation methods by the fixing tools 30 may be used in combination. Note that a surface 12b of the resin layer 11 of the thermally expandable fire-resistant sheet 1 opposite from the inorganic layer 12 may be superposed on the architectural structure portion 20 and may be secured with the fixing tool 30.

As described above, the thermally expandable fire-resistant sheet 1 is suitably applicable to wooden structural members, metal structural members, wooden underlying members, inorganic underlying members, and the like.

3. Summary

As described above, a thermally expandable fire-resistant resin composition of a first aspect includes a metallocene plastomer (A); a nitrogen-containing foaming agent (B); a phosphorus flame retardant (C); a polyhydric alcohol (D); and a titanium dioxide (E).

This aspect enables an excellent gas barrier property to be imparted to a resin layer (11) formed from the thermally expandable fire-resistant resin composition, thereby imparting long-term durability to the resin layer (11) formed from the thermal expansion refractory resin composition. Moreover, a thermally expandable fire-resistant sheet (1) is provided with conformability suitable for an architectural structure portion (20) such as an underlying member (21). Furthermore, this aspect enables a foamed heat-insulating layer having excellent heat insulating property from fire heat or the like to be formed from the resin layer (11). Therefore, the thermally expandable fire-resistant sheet (1) including the resin layer (11) containing the thermally expandable fire-resistant resin composition is fire-resistant and durable for a long period of time, and excellent shape retainability and an excellent conformability of the foamed resin layer are realized.

The thermally expandable fire-resistant resin composition of a second aspect referring to the first aspect further includes a polymer (F). The polymer (F) has a water vapor transmission rate which is defined by JIS K7129 and which is less than or equal to 100 g/m²·24 h.

This aspect enables the gas barrier property and the conformability to the underlying member and the like of the thermally expandable fire-resistant sheet (1) to be further improved while the shape retainability of a foamed heat-insulating layer formed by expanding and foaming, by fire heat, the resin layer (11) formed from the thermally expandable fire-resistant resin composition is maintained.

In a thermally expandable fire-resistant resin composition of a third aspect referring to the first or second aspect, a content of the metallocene plastomer (A) based on 100 parts by mass of a solid content of the thermally expandable fire-resistant resin composition is greater than or equal to 15 parts by mass and less than or equal to 40 parts by mass.

This aspect enables a foamed heat-insulating layer to be formed which is hard to fall off even when the thermally expandable fire-resistant sheet (1) expands and foams due to fire flame while the gas barrier property and the conformability to the underlying material or the like of the thermally expandable fire-resistant sheet (1) containing the thermally expandable fire-resistant resin composition are secured. Therefore, in the thermally expandable fire-resistant sheet (1), the shape retainability of the foamed heat-insulating layer when exposed to fire heat or the like is improved, and thus, spread of burning and falling off of the thermally expandable fire-resistant sheet (1) by fire heat are suppressed.

A thermally expandable fire-resistant sheet (1) of a fourth aspect includes a resin layer (11) formed from the thermally expandable fire-resistant resin composition of any one of the first to third aspects.

With this aspect, a thermally expandable fire-resistant sheet (1) is realizable which is fire-resistant and durable for a long period of time and having excellent shape retainability and an excellent conformability of the foamed resin layer.

A thermally expandable fire-resistant sheet (1) according to a fifth aspect referring to the fourth aspect further includes an inorganic layer (12) on the resin layer (11). The inorganic layer (12) contains glass fiber.

When the thermally expandable fire-resistant sheet (1) is expanded and foamed by fire heat to form a foamed heat-insulating layer from the resin layer (11), this aspect further reduces falling off of the foamed heat-insulating layer.

A method of a sixth aspect is a method for installing the thermally expandable fire-resistant sheet of the fourth or fifth aspect and includes fixing the thermally expandable fire-resistant sheet (1) to an architectural structure portion (20) with a fixing tool (30).

With this aspect, even when, at the time of fixing the thermally expandable fire-resistant sheet (1) to the underlying member (21) or the like, the thermally expandable fire-resistant sheet (1) having a relatively large area is fixed, the foamed heat-insulating layer does not easily fall off even in the case of exposure to fire heat or the like. Thus, the thermally expandable fire-resistant sheet (1) is fixed to the architectural structure portion (20) and is suitably usable as a fire resistance material.

Example

The present disclosure will be described further in detail with reference to examples below. However, the present disclosure is not limited to the following examples, and various modifications may be made depending on design as long as the object of the present disclosure is achieved.

(1) Preparation of Thermally Expandable Fire-Resistant Resin Composition

A metallocene plastomer (A), a nitrogen-containing foaming agent (B), a phosphorus flame retardant (C), a polyhydric alcohol (D), a titanium dioxide (E), and a processing aid at content amounts shown in Table 1 were kneaded with a pressurized kneader at 130° C., thereby preparing a thermally expandable fire-resistant resin composition. Note that in Examples 6 to 10 and Comparative Examples 1 to 2, a polymer (F) was, together with the above-described components, blended at a content shown in Tables 1 and 2. Details of the components shown in Table 1 are as shown below.
Metallocene plastomer A: C6 series, MFR: 8.0 g/10 min (Sumitomo Chemical Company, Limited, product name: EXCELLEN FX402).
Metallocene plastomer B: C4 series, MFR: 2.0 g/10 min (Japan polyethylene Corporation, product name: Kernel 260F).
Nitrogen-containing foaming agent A: Melamine (Nissan Chemical Corporation).
Nitrogen-containing foaming agent B: dicyandiamide (Mitsubishi Chemical Corporation, product name: DICY7).
Inorganic foaming agent: Otsuka Chemical Co. Ltd., product name: P-5.
Phosphorus flame retardant A: ammonium polyphosphate (Clariant Japan K.K., product name: AP422).
Phosphorus flame retardant B: aluminum phosphite (Taihei Chemical Industrial Co. Ltd., product name: APA100).
Polyhydric alcohol: pentaerythritol (KOEI CHEMICAL COMPANY, LIMITED, product name: dipentalite).
Titanium dioxide: average particle diameter 0.24 μm (Huntsman Corporation, product name: TR92).
Calcium carbonate: Shiraishi Kogyo Kaisha, Ltd., product name: BF300.
Polymer A: butyl rubber

Water vapor transmission rate: 58 g/m²·24 h (JSR Corporation, product name: JSR065).
Polymer B: polyethylene
   Water vapor transmission rate: 3.5 g/m²·24 h (Sumitomo Chemical Company, Limited, product name: SUMIKATHENE GH030).

Polymer C: ethylene vinyl acetate copolymer

Water vapor transmission rate: 3.1 g/m²·24 h (TOSOH CORPORATION, product name: Ultrasen (Nipoflex) 722).

Polymer D: PVC

Water vapor transmission rate: 7.3 g/m² (product name from Kaneka Corporation: PSL-675).

Processing aid: Mitsubishi Chemical Corporation, product name: METABLEN A3000

(2) Preparation of Thermally Expandable Fire-Resistant Sheet and Preparation of Specimens

Next, the thermally expandable fire-resistant resin composition was applied to one side of a glass paper (manufactured by Oji F-Tex Co., Ltd.) having a basis weight of 50 g/m² and was molded with a heated press set at 100° C. This provided a thermally expandable fire-resistant sheet including: a resin layer formed from the thermally expandable fire-resistant resin composition; and a heat-resistant sheet on the resin layer. The thickness of the resin layer of the thermally expandable fire-resistant sheet thus obtained was 1.0 mm. Subsequently, two calcium silicate boards each having a thickness of 10 mm were prepared as underlying members (wall underlying members). After these two calcium silicate boards were stacked on each other, the surface of the glass paper of the thermally expandable sheet was placed on one of the calcium silicate boards and was fixed with a fixing tool by using a tucker. Subsequently, a calcium silicate board having a thickness of 12 mm was prepared as a surface material, and a stud was fixed to a (resin layer) side of the thermally expandable sheet of the wall underlying member to which the thermally expandable sheet was fixed such that a gap of 20 mm was formed between the surface material and the wall underlying member to which the thermally expandable sheet was fixed. Then, the surface material was fixed to the stud, thereby preparing a specimen including: a wall underlying member provided with the thermally expandable fire-resistant sheet; the stud; and the surface material in this order.

(3) Evaluation Test

(3-1) Fire Resistance

In accordance with the standard time/temperature curve of JIS A1304, the specimen was heated in an electric furnace, and the highest attainable temperature of an opposite surface of the specimen from the interior of the electric furnace after 1 hour from a start of heating was measured by a thermocouple and was evaluated as described below. Results of the evaluation are shown in Tables 1 and 2.

A: The highest attainable temperature is lower than 162° C.
B: The highest attainable temperature is higher than or equal to 162° C. and lower than or equal to 200° C.
C: The highest attainable temperature is higher than 200° C.

(3-2) Shape Retainability

In accordance with JIS A1304, the state of a burned residue (foamed heat-insulating layer) of the thermally expandable fire-resistant sheet after a 1-hour fire-resistance test of the specimen was visually evaluated based on the following criteria. Results of the evaluation are shown in Tables 1 and 2.

A: No burned residue fell from the specimen.
B: Some of the burned residue fell from the specimen.
C: Most of the burned residue fell from the specimen.

(3-3) Conformability (Resistance to Bendability)

In accordance with JIS K5600-5-1 (bend test (cylindrical mandrel)), the state of cracks in the thermally expandable fire-resistant sheet of the specimen when the specimen was bent was visually evaluated based on the following criteria. Results of the evaluation are shown in Tables 1 and 2.

A: No crack was observed, or a fine crack was observed with the diameter of the mandrel being smaller than 5 mm.
B: A large crack was observed with the diameter of the mandrel being smaller than 5 mm, but no crack was observed, or a fine crack was observed with the diameter of the mandrel being larger than or equal to 5 mm.
C: A large crack was observed with the diameter of the mandrel being larger than or equal to 5 mm.

(3-4) Freezing and Thawing Durability (Durability under Freezing and thawing Condition)

In accordance with JIS A1435 (method of test for resistance of exterior materials of buildings to freezing and thawing), the specimen was subjected to 50 cycles of freezing in air and thawing in air. Then, the fire resistance and the conformability of the thermally expandable fire-resistant sheet in the specimen were determined based on similar evaluation criteria to those in (3-1) and (3-3) and were evaluated based on the following criteria. Results of the evaluation are shown in Tables 1 and 2.

A: No crack was observed or a fine crack was observed when the thermally expandable fire-resistant sheet is fire-resistant in the above-described evaluation, the highest attainable temperature of lower than 162° C., and the thermally expandable fire-resistant sheet has conformability with the diameter of the mandrel being smaller than 5 mm.
B: Other than A and C.
C: A large crack was observed when the thermally expandable fire-resistant sheet is fire-resistant in the above-described evaluation and the highest attainable temperature is higher than 200° C. or the thermally expandable fire-resistant sheet has conformability in the above-described evaluation with the diameter of the mandrel being larger than or equal to 5 mm.

(3-5) High Temperature and Humidity Durability (Durability under Hot and Humid Condition)

A program was performed 50 cycles, where 1 cycle is determined to be a set of 18 hours under a temperature of 40° C. and a humidity of 95% and 6 hours under a temperature of 60° C. Then, the fire resistance and the conformability of the thermally expandable fire-resistant sheet in the specimen were determined based on similar evaluation criteria to those in (3-1) and (3-3) and were evaluated based on the following criteria. Results of the evaluation are shown in Tables 1 and 2. A: No crack was observed or a fine crack was observed when thermally expandable fire-resistant sheet is fire-resistant, the highest attainable temperature of lower than 162° C., and the thermally expandable fire-resistant sheet has conformability with the diameter of the mandrel being smaller than 5 mm. B: Other than A and CC: A large crack was observed when the thermally expandable fire-resistant sheet is fire-resistant and the highest attainable temperature is higher than 200° C. or the thermally expandable fire-resistant sheet has conformability with the diameter of the mandrel being larger than or equal to 5 mm.

TABLE 1

| | | Example | Example | Example | Example | Example | Example |
|---|---|---|---|---|---|---|---|
| | | 1 | 2 | 3 | 4 | 5 | 6 |
| (A) | Metallocene | 24 | — | 28 | 24 | 20 | 20 |
| | Plastomer A | | | | | | |
| | Metallocene | — | 24 | — | — | — | — |
| | Plastomer B | | | | | | |
| (B) | Nitrogen Containing | 10 | 10 | 20 | — | 15 | 10 |
| | Foaming Agent A | | | | | | |
| | Nitrogen Containing | — | — | — | 20 | — | — |
| | Foaming Agent B | | | | | | |
| — | Inorganic Foaming | — | — | — | — | — | — |
| | Agent | | | | | | |
| (C) | Phosphorus-Based | 30 | 30 | 30 | 30 | 10 | 30 |
| | Flame Retardant A | | | | | | |
| | Phosphorus-Based | — | — | — | — | 20 | — |
| | Flame Retardant B | | | | | | |
| (D) | Polyhydric Alcohol | 20 | 20 | 5 | 10 | 24 | 20 |
| (E) | Titanium Dioxide | 15 | 15 | 15 | 15 | 10 | 15 |
| — | Calcium Carbonate | — | — | — | — | — | — |
| (F) | Polymer A | — | — | — | — | — | 4 |
| | Polymer B | — | — | — | — | — | — |
| | Polymer C | — | — | — | — | — | — |
| | Polymer D | — | — | — | — | — | — |
| — | Processing Aid | 1 | 1 | 2 | 1 | 1 | 1 |
| Ratio by Weight [B/D] | | 0.5 | 0.5 | 4.0 | 2.0 | 0.6 | 0.5 |
| Ratio by Weight [A/F] | | — | — | — | — | — | 5.0 |
| Evaluation | Fire Resistance | A | A | A | A | A | A |
| Result | Shape Retainability | A | A | A | A | A | A |
| | Conformability | A | A | A | A | A | A |
| | Freezing and Thawing | A | A | A | A | A | A |
| | Durability | | | | | | |
| | High Temperature and | A | A | A | A | A | A |
| | Humidity Durability | | | | | | |

| | | | Example | Example | Example | Example |
|---|---|---|---|---|---|---|
| | | | 7 | 8 | 9 | 10 |
| | (A) | Metallocene | 15 | 20 | 20 | 20 |
| | | Plastomer A | | | | |
| | | Metallocene | — | — | — | — |
| | | Plastomer B | | | | |
| | (B) | Nitrogen Containing | 10 | 10 | 10 | 10 |
| | | Foaming Agent A | | | | |
| | | Nitrogen Containing | — | — | — | — |
| | | Foaming Agent B | | | | |
| | — | Inorganic Foaming | — | — | — | — |
| | | Agent | | | | |
| | (C) | Phosphorus-Based | 34 | 30 | 30 | 30 |
| | | Flame Retardant A | | | | |
| | | Phosphorus-Based | — | — | — | — |
| | | Flame Retardant B | | | | |
| | (D) | Polyhydric Alcohol | 15 | 20 | 20 | 20 |
| | (E) | Titanium Dioxide | 16 | 15 | 15 | 15 |
| | — | Calcium Carbonate | — | — | — | — |
| | (F) | Polymer A | 9 | — | — | — |
| | | Polymer B | — | 4 | — | — |
| | | Polymer C | — | — | 4 | — |
| | | Polymer D | — | — | — | 4 |
| | — | Processing Aid | 1 | 1 | 1 | 1 |
| Ratio by Weight [B/D] | | | 0.7 | 0.5 | 0.5 | 0.5 |
| Ratio by Weight [A/F] | | | 1.7 | 5.0 | 5.0 | 5.0 |
| | Evaluation | Fire Resistance | A | A | A | A |
| | Result | Shape Retainability | A | A | A | A |
| | | Conformability | A | A | A | A |
| | | Freezing and Thawing | A | A | A | A |
| | | Durability | | | | |
| | | High Temperature and | A | A | A | A |
| | | Humidity Durability | | | | |

| | | Example | Example | Example | Example | Example |
|---|---|---|---|---|---|---|
| | | 11 | 12 | 13 | 14 | 15 |
| (A) | Metallocene | 28 | 28 | 18 | 35 | 9 |
| | Plastomer A | | | | | |
| | Metallocene | — | — | — | — | — |
| | Plastomer B | | | | | |
| (B) | Nitrogen Containing | 23 | 8 | 12 | 10 | 10 |
| | Foaming Agent A | | | | | |
| | Nitrogen Containing | — | — | — | — | — |
| | Foaming Agent B | | | | | |
| — | Inorganic Foaming | — | — | — | — | — |
| | Agent | | | | | |
| (C) | Phosphorus-Based | 25 | 25 | 29 | 24 | 30 |
| | Flame Retardant A | | | | | |
| | Phosphorus-Based | — | — | — | — | — |
| | Flame Retardant B | | | | | |
| (D) | Polyhydric Alcohol | 7 | 22 | 20 | 15 | 20 |
| (E) | Titanium Dioxide | 15 | 15 | 20 | 15 | 15 |
| — | Calcium Carbonate | — | — | — | — | — |
| (F) | Polymer A | — | — | — | — | 15 |
| | Polymer B | — | — | — | — | — |
| | Polymer C | — | — | — | — | — |
| | Polymer D | — | — | — | — | — |
| — | Processing Aid | 2 | 2 | 1 | 1 | 1 |
| Ratio by Weight [B/D] | | 3.3 | 0.4 | 0.6 | 0.7 | 0.5 |
| Ratio by Weight [A/F] | | — | — | — | — | 0.6 |
| Evaluation | Fire Resistance | B | A | A | B | A |
| Result | Shape Retainability | B | A | A | B | A |
| | Conformability | A | B | B | A | B |
| | Freezing and Thawing | A | B | B | B | B |
| | Durability | | | | | |
| | High Temperature and | A | B | B | B | B |
| | Humidity Durability | | | | | |

| | | Comparative | Comparative | Comparative | Comparative |
|---|---|---|---|---|---|
| | | Example 1 | Example 2 | Example 3 | Example 4 |
| (A) | Metallocene | — | — | 24 | 24 |
| | Plastomer A | | | | |
| | Metallocene | — | — | — | — |
| | Plastomer B | | | | |
| (B) | Nitrogen Containing | 20 | 10 | — | 10 |
| | Foaming Agent A | | | | |
| | Nitrogen Containing | — | — | — | — |
| | Foaming Agent B | | | | |
| — | Inorganic Foaming | — | — | 10 | — |
| | Agent | | | | |
| (C) | Phosphorus-Based | 30 | 30 | 30 | 30 |
| | Flame Retardant A | | | | |
| | Phosphorus-Based | — | — | — | — |
| | Flame Retardant B | | | | |
| (D) | Polyhydric Alcohol | 5 | 20 | 20 | 20 |
| (E) | Titanium Dioxide | 15 | 15 | 15 | — |
| — | Calcium Carbonate | — | — | — | 15 |
| (F) | Polymer A | — | 24 | — | — |
| | Polymer B | 28 | — | — | — |
| | Polymer C | — | — | — | — |
| | Polymer D | — | — | — | — |
| — | Processing Aid | 2 | 1 | 1 | 1 |
| Ratio by Weight [B/D] | | 4.0 | 0.5 | 0.5 | 0.5 |
| Ratio by Weight [A/F] | | — | — | — | — |
| Evaluation | Fire Resistance | C | C | C | C |
| Result | Shape Retainability | C | C | C | C |
| | Conformability | A | A | B | A |
| | Freezing and Thawing | B | C | C | C |
| | Durability | | | | |
| | High Temperature and | B | C | C | C |
| | Humidity Durability | | | | |

### REFERENCE SIGNS LIST

1 THERMALLY EXPANDABLE FIRE-RESISTANT SHEET
11 RESIN LAYER
12 INORGANIC LAYER
20 ARCHITECTURAL STRUCTURE PORTION
21 UNDERLYING MEMBER
30 FIXING TOOL

1. A thermally expandable fire-resistant resin composition, comprising:
a metallocene plastomer (A);
a nitrogen-containing foaming agent (B);
a phosphorus flame retardant (C);
a polyhydric alcohol (D); and
a titanium dioxide (E).

2. The thermally expandable fire-resistant resin composition of claim 1, further comprising:
a polymer (F), wherein
the polymer (F) has a water vapor transmission rate which is defined by JIS K7129 and which is less than or equal to 100 g/m2·24 h.

3. The thermally expandable fire-resistant resin composition of claim 1, wherein
a content of the metallocene plastomer (A) based on 100 parts by mass of a solid content of the thermally expandable fire-resistant resin composition is greater than or equal to 15 parts by mass and less than or equal to 40 parts by mass.

4. A thermally expandable fire-resistant sheet, comprising a resin layer formed from the thermally expandable fire-resistant resin composition of claim 1.

5. The thermally expandable fire-resistant sheet of claim 4, further comprising:
an inorganic layer on the resin layer, wherein
the inorganic layer contains glass fiber.

6. A method for installing the thermally expandable fire-resistant sheet of claim 4, the method comprising fixing the thermally expandable fire-resistant sheet to an architectural structure portion with a fixing tool.
